(19) United States
(12) Patent Application Publication
(10) Pub. No.: US 2024/0231920 A1
(43) Pub. Date: Jul. 11, 2024

(54) ENERGY EFFICIENT WORKLOAD SERVICE SELECTION

(71) Applicant: International Business Machines Corporation, Armonk, NY (US)

(72) Inventors: Peng Hui Jiang, Beijing (CN); Fan Jing Meng, Beijing (CN); Guang Han Sui, Beijing (CN); Jun Su, Beijing (CN); Li Jian Wang, Beijing (CN); Chen Ji, Beijing (CN)

(21) Appl. No.: 18/150,558

(22) Filed: Jan. 5, 2023

(51) Int. Cl. G06F 9/50

(52) U.S. Cl. CPC G06F 9/5027

(57) ABSTRACT

A system may include a memory and a processor in communication with the memory. The processor may be configured to perform operations. The operations may include receiving a task request from a user and determining a preferred executor type for the task request. The operations may include selecting an executor of the preferred executor type for the task request. The operations may include performing the task request with the executor and returning a response to the task request to the user.

### BACKGROUND

The present disclosure relates to distributed systems, and, more specifically, to workload management in distributed systems.

A user may run an application, and cloud computing services may provide users an ability to develop, launch, run, and/or manage application functionality without the need to build and maintain the associated infrastructure. An existing infrastructure may be provisioned by a user such that the user may run the application on an infrastructure built and/or maintained by another entity (e.g., a cloud services provider).

Cloud resources may be provisioned, re-provisioned, scaled, and/or destroyed as needs arise and/or diminish. Cloud resources may enable resource allocation, fast response time, schedulability, scalability, reliability, and upgradability. Cloud resource option types may include, for example, serverless architecture and microservice containerized architecture. Certain cloud resources may optimally be used for a certain application type, and/or an application may preferentially be executed with a certain cloud resource type. A system management goal may be to maximize utilization of the system, including, for example, power consumption, costs for executing tasks, overall system efficiency, and the like. Optimizing the selection of a service for a particular workload may improve the utilization of a system.

### SUMMARY

Embodiments of the present disclosure include a system, method, and computer program product for selecting a service for a workload.

A system may include a memory and a processor in communication with the memory. The processor may be configured to perform operations. The operations may include receiving a task request from a user and determining a preferred executor type for the task request. The operations may include selecting an executor of the preferred executor type for the task request. The operations may include performing the task request with the executor and returning a response to the task request to the user.

In some embodiments of the present disclosure, the operations may include obtaining usage data and analyzing the usage data to identify a usage pattern. In some embodiments of the present disclosure, the operations may further include building a resource selection model from the usage pattern and identifying the preferred executor type with the resource selection model. In some embodiments of the present disclosure, the resource selection model may be a cost model such that the cost is calculated by the model for each resource option; in such embodiments, the resource selection model may be referred to as a resource selection cost model or a resource selection cost-based model. In some embodiments of the present disclosure, the operations may include adjusting a lifecycle of the executor based on the usage data.

In some embodiments of the present disclosure, the preferred executor type may be selected from a group consisting of serverless type, microservice type, and mixed service type.

In some embodiments of the present disclosure, the operations may include converting an executor from a first executor type to a second executor type.

In some embodiments of the present disclosure, the operations may include scaling resources of the executor.

In some embodiments of the present disclosure, the operations may include detecting the executor has inadequate resources to execute the task request. In some embodiments, the operations may include balancing and/or scaling resources in the system to enable the system to execute the task. In some embodiments, the operations may include queuing the task or scheduling the task for a later time.

A computer-implemented method in accordance with the present disclosure may include receiving a task request from a user and determining a preferred executor type for the task request. The method may include selecting an executor of the preferred executor type for the task request. The method may include performing the task request with the executor and returning a response to the task request to the user.

A computer program product in accordance with the present disclosure may include a computer readable storage medium having program instructions embodied therewith. The program instructions may be executable by a processor to cause the processor to perform a function. The function may include receiving a task request from a user and determining a preferred executor type for the task request. The function may include selecting an executor of the preferred executor type for the task request. The function may include performing the task request with the executor and returning a response to the task request to the user.

The above summary is not intended to describe each illustrated embodiment or every implementation of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates an architecture of a service provision system in accordance with some embodiments of the present disclosure.

FIG. 2 depicts a resource management system in accordance with some embodiments of the present disclosure.

FIG. 3 illustrates an architecture of a service selection system in accordance with some embodiments of the present disclosure.

FIG. 4 depicts an executor configuration mechanism in accordance with some embodiments of the present disclosure.

FIG. 5 illustrates a dataset of resource monitoring graphs in accordance with some embodiments of the present disclosure.

FIG. 6 depicts a computer implemented service selection method in accordance with some embodiments of the present disclosure.

FIG. 7 illustrates a computer implemented service selection method in accordance with some embodiments of the present disclosure.

FIG. 8 depicts a block diagram illustrating an embodiment of a computer system, and the components thereof, upon which embodiments described herein may be implemented in accordance with the present disclosure.

FIG. 9 depicts a block diagram illustrating an extension of the computing system environment of FIG. 8 wherein the computer systems are configured to operate in a network environment (including a cloud environment) and perform methods described herein in accordance with the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to distributed systems, and, more specifically, to workload management in distributed systems.

One or more cloud resources and/or resource types (e.g., serverless architecture and/or microservice containerized architecture) may optimally be used for one or more certain application and/or task types. Similarly, an application or task may preferentially be executed with a certain cloud resource type. A system management goal may be to maximize utilization of the system, including, for example, power consumption, task execution costs, overall system efficiency, and the like. Maximizing the utilization of a system may include pairing tasks and/or applications with a preferred resource type for that task and/or application.

Cloud service resource types may include, for example, serverless and microservice types. Some services may provide infrastructure such that a user may use an application without the complexity of building and maintaining the infrastructure that it would require. For example, function as a service (FaaS) is a category of cloud computing services that provides a user the ability to develop, run, and/or manage application functionalities without building and/or maintaining the infrastructure which otherwise would typically be associated with developing and launching an application.

FaaS resources may be provisioned and destroyed frequently to achieve a serverless architecture. FaaS may be used when building microservices applications. Using FaaS may ensure resource allocation, fast response time, schedulability, scalability, resiliency, and upgradability. Microservices may be preferred for long-running tasks as they may reduce the time of provision and/or destruction of a resource for a service compared to FaaS with the tradeoff that the resources may be occupied even if there is no request against (e.g., task being executed by) these services.

Selecting an optimal service type (e.g., microservice or serverless architecture) and an optimal service (e.g., host node) for a task or application may enable the maximization of resources in a system. However, selecting an optimal service type and/or service of that type from the available choices may be a challenge. Moreover, from the perspective of minimizing cost (including, for example, energy, compute power, and time), one workload may have a different power usage effectiveness (PUE) for each computing resource option despite that the provided functionality is the same. Thus, there is no one-size-fits-all strategy. Some embodiments of the present disclosure offer a flexible mechanism for selecting an optimal service type and service host customized to the requested workload and the resources available.

In accordance with the present disclosure, resources may be dynamically scaled to offer a preferred service type (e.g., serverless or microservice) and/or service (e.g., host node or task executor) of the preferred service type for the particular task requested. In some embodiments, the service type and/or service may be selected, at least in part, based on a resource maximizing (e.g., energy saving) model. In some embodiments, the model used for selecting a preferred service type and/or service may be an artificial intelligence (AI) model.

Some embodiments of the present disclosure may collect usage data. The usage data may be information about the services in the system (e.g., FaaS and microservices). For example, usage data may include data about the services (e.g., type, uptime, compute power available, and schedule), the tasks requested of each service, and the PUE of a service when used for a particular task. A resource monitor may be used to collect the usage data.

The usage data may be used to identify trends in the data (e.g., identify which services have the best PUE for a particular task) and use the trends to optimize use of the system. Trends and patterns may be identified about workload types, recurring workloads, resource consumption (e.g., time and energy cost), and the like. The usage data and/or the metadata may be used to develop a resource selection model; in some embodiments, the resource selection model may optimize system use based on cost (e.g., the PUE), and such a model may be referred to as a resource selection cost model, a cost-optimizing resource selection model, or similar. A resource analyzer may be used to analyze the usage data for patterns, trends, and other metadata. In some embodiments, a resource analyzer may be used to analyze usage patterns and build or facilitate the building of the resource selection model with the resulting analysis.

In accordance with the present disclosure, a system (e.g., a distributed workload service system) may accept one or more task requests from one or more users; a user may be, for example, an individual, an organization, a corporation, a business unit, or some other entity. The system may process the one or more task requests by determining a host (e.g., using a resource selection model to select an optimal service), assigning the task to the host, and either scheduling (e.g., queuing for execution upon resources becoming available or selecting a future time for execution) the execution of the task or immediately executing the task. In some embodiments, scheduling a task may be used to maximize system utilization via optimal resource selection in conjunction with asynchronous processing.

Usage data, usage patterns, and the analysis thereof may be used to predict task requests (e.g., incoming workloads) and the resource requirements of task requests (e.g., the amount of compute power, memory, and time tasks will use) both realized (e.g., received and queued) and predicted (e.g., expected to be received at a certain future time). Usage data, patterns, and analysis may also be used to determine what type of executor (e.g., serverless node or microservice node) may be preferred and/or optimal for a particular task request. For example, usage data analysis of a task type may identify that microservices provide the optimal PUE for a received task.

In accordance with the present disclosure, a system may monitor resources of services and/or of specific executors of each available service type. In some circumstances, the system may identify that one service type is optimal for a task on an energy cost basis but that it may not have the resources available and that scheduling the task for later is not ideal; the system may adapt to the need by, for example, scaling the available resources, assigning a less optimal executor, and/or changing an executor from one service type to another service type. For example, a system may receive a task that requires immediate processing, and the system may identify that a serverless node would be optimal for servicing the task but that the serverless nodes are at capacity; the system may determine that the best solution is to exchange system resources by reconfiguring a microservice node into a mixed service node (e.g., a node offering microservice and serverless resources) to service the task with the mixed service node.

In some embodiments, the system may elect to scale out (e.g., increase the capacity of a service in the system by increasing the resources available to a node in that service) or scale up (e.g., increase the number of nodes available within a service) one or more services. An analysis (e.g., of usage data, patterns, trends, and/or one or more models) may be used to determine whether to scale out or scale up available resources for one or more service types. In some embodiments, a scale manager may be used to check the available resources of one or more executors, identify an opportunity for scaling, and perform the resource scaling.

In some embodiments, the metrics of the services may be collected and used to adjust the lifecycles of one or more of the services. For example, the metrics of a FaaS may be collected and used to alter the lifecycle of a serverless resource according to the usage pattern. In some embodiments, the usage pattern of an entire service system (e.g., both serverless and microservice offerings) may be used to alter the lifecycles of multiple services in the system to optimize the system and/or system offerings. For example, analysis of usage data may identify that the system uses more than necessary resources for microservices and would be better served by shifting some of the resources to serverless hosts; the system may alter the lifecycles of both the microservice and the serverless hosts to adjust to a more optimal service offering.

The usage data, patterns, and analysis thereof may be used to adjust lifecycles so as to optimize the system based on the tasks statistically serviced. For example, serverless (e.g., FaaS) services may be optimally used for frequent provisioning and/or destruction; a resource model could evaluate some serverless services and determine that one of the serverless services could ideally reconfigured into a long-run service (e.g., a microservice), and the system could direct that serverless service for reconfiguration into a microservice whereas the other serverless services may remain as serverless services. Similarly, in another example, long running microservices may be evaluated, and the system may determine that one of the microservices has infrequent usage; that microservice may be evaluated as “save” by the cost model and converted into FaaS.

In some systems, analysis of usage data may not reveal any usage patterns; for example, a system may be relatively new such that no usage patterns are discernable yet for one or more of the offered services. For a service without a recognized usage pattern, the system may provision the service as one type of service and adjust the service offering as more data becomes available. For example, a service without an identified usage pattern may be provisioned as a long running microservice; as usage data becomes available and as analysis identifies patterns in the data, the service may be pruned, adjusted, cleaned, and/or optimized according to usage model updates.

In some embodiments of the present disclosure, an intelligent mechanism may be used to dynamically scale services such as microservices and/or serverless services. Some embodiments of the present disclosure may resolve one or more limitations regarding the timely changing of cloud resources according to use of a system. Some embodiments may be used to convert services and/or service resources from one type to another type according to system usage, for example, from FaaS to microservice or vice versa; converting services between types may be difficult to manually administer, particularly if a platform faces frequent changes, and the present disclosure may be used to enable and/or facilitate such conversions. In some embodiments, the present disclosure may be used to alleviate and/or resolve resource pool balance issues in a system (e.g., a cloud platform system).

In accordance with the present disclosure, cloud services (e.g., microservices and/or serverless services) may be dynamically managed so as to enable conversion of resources (e.g., scaling in of serverless resources and using those resources to scale out microservice resources, or vice versa) and services between service types (e.g., converting a service from microservice type to serverless service type, or vice versa). In some embodiments, the disclosure may enable and/or enhance the ability of a system to determine a preferred and/or optimal variant (e.g., specific node) for the same service type (e.g., serverless service type or microservice type) based on user priorities such as, for example, reducing resource consumption and/or minimizing the cost of execution.

Some embodiments of the present disclosure may employ lifecycle management techniques over a system to optimize the system. Lifecycle management may be used, for example, to resolve resource pool balance issues by redistributing unused resources to services that could benefit from additional resources. For example, a system may include a microservice cluster with ten nodes and a serverless cluster with ten nodes, and the microservice cluster may be using only two of its nodes whereas the serverless cluster may be using all ten of its nodes and have a queue; lifecycle management may be used to redistribute resources from the microservice cluster to the serverless cluster to balance the resources to the demands made on the system.

In some embodiments of the present disclosure, a model may be used to help optimize a system such as by, for example, directing lifecycle management decisions based on a priority to minimize energy usage and/or cost. The model may enable and/or enhance dynamic scaling of cloud services by, for example, identifying resource use for a task in each execution environment so as to compare the resource use calculations and select the optimal executor, basing the decision, at least in part, on the calculations made using the resource use data. In some embodiments, the model may be weighted to account for one or more user preferences (e.g., time may be the most important resource for one task whereas energy consumption may be more important for another task). In some embodiments, the model may be an AI model.

A system in accordance with the present disclosure may include a memory and a processor in communication with the memory. The processor may be configured to perform operations. The operations may include receiving a task request from a user and determining a preferred executor type for the task request. The operations may include selecting an executor of the preferred executor type for the task request. The operations may include performing the task request with the executor and returning a response to the task request to the user.

In some embodiments of the present disclosure, the operations may include obtaining usage data and analyzing the usage data to identify a usage pattern. In some embodiments, the operations may further include building a resource selection model from the usage pattern and identifying the preferred executor type with the resource selection model. In some embodiments, the resource selection model may be a cost model such that the cost is calculated by the model for each resource option; in such embodiments, the resource selection model may be referred to as a resource selection cost model or a resource selection cost-based model. In some embodiments, the operations may include adjusting a lifecycle of the executor based on the usage data.

In some embodiments of the present disclosure, the preferred executor type may be selected from a group consisting of serverless type, microservice type, and mixed service type.

In some embodiments of the present disclosure, the operations may include converting an executor from a first executor type to a second executor type. For example, the operations may include converting a microservice node to a serverless node or vice versa.

In some embodiments of the present disclosure, the operations may include scaling resources of the executor. In some embodiments, the function may include scaling in or scaling down the resources of another executor and reallocating the resources to the executor.

In some embodiments of the present disclosure, the operations may include detecting the executor has inadequate resources to execute the task request. In some embodiments, the operations may include balancing and/or scaling resources in the system to enable the system to execute the task. In some embodiments, the operations may include queuing the task or scheduling the task for a later time.

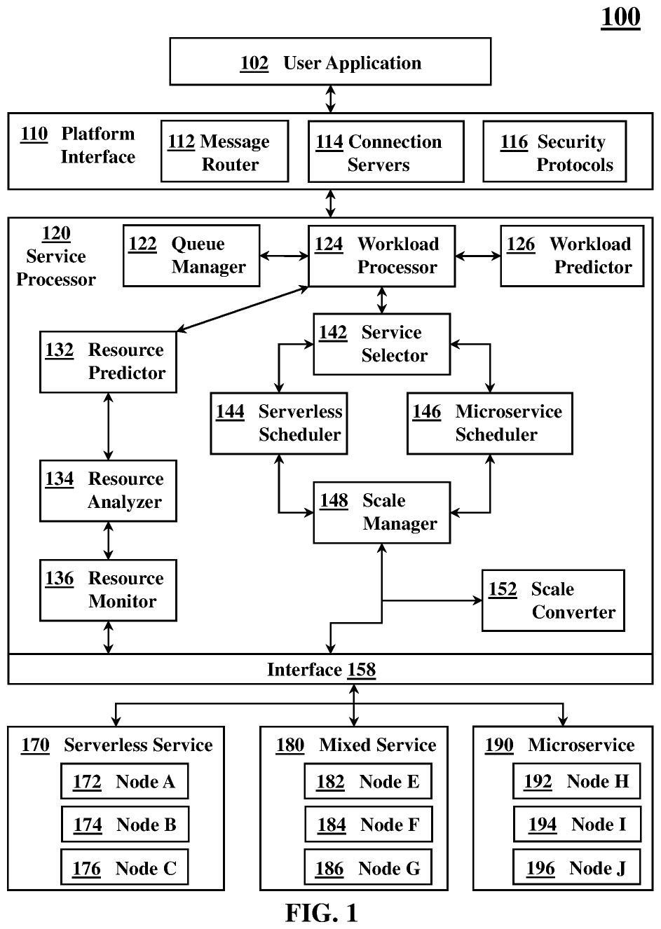

FIG. 1 illustrates an architecture of a service provision system 100 in accordance with some embodiments of the present disclosure. The service provision system 100 includes a user application 102 communicating with a service processor 120 via a platform interface 110. The service processor 120 communicates with various service offerings via an interface 158.

The user application 102 communicates with the platform interface 110 (e.g., to submit a task request or receive a result). The platform interface 110 may include a message router 112, one or more connection servers 114, and one or more security protocols 116.

The platform interface 110 may communicate with the service processor 120. The service processor 120 may field a task request with a queue manager 122. The queue manager 122 may notify a workload processor 124 of a task request from the user application 102. The workload processor 124 may also be in communication with a workload predictor 126. The workload predictor 126 may use usage data to identify workload patterns and predict workloads that an entity may submit; the workload predictor 126 may store data internally, elsewhere on the platform, or externally. The workload predictor 126 may notify the workload processor 124 of anticipated workloads so as to optimize resource use of system services.

The workload processor 124 may be in communication with a resource predictor 132. The resource predictor 132 may predict the resources that will be necessary for the system to execute the workload of the task request and/or the resources that a system has or will have available for executing the task. The resource predictor 132 is in communication with a resource analyzer 134 which may analyze usage data of the system services; the usage data may be collected by a resource monitor 136. The resource monitor 136 may oversee and/or communicate with the services directly and/or may communicate with the services via an interface 158. The resource monitor 136 may collect service usage data, the resource analyzer 134 may analyze the data, and the resource predictor 132 may use the analysis to predict the resources necessary for a task, the resources currently available in the system and/or from each service offering (e.g., what available resources are currently assigned to the serverless service 170 cluster and which are assigned to the microservice 190 cluster), differing resource requirements required for the task based on the service used to execute the task, and the like.

The resource predictor 132 may predict resources necessary to execute a particular task or a group of tasks; the resource predictor 132 may predict the resources that are available in the system, that will be available in the system at a future time, whether the current resources are enough to service all current and predicted tasks, whether one or more of the services should be scaled to adequately and/or optimally service tasks, and the like.

In some embodiments, more than one resource predictor 132 may be used. For example, a resource predictor 132 may be defined for each variant executor of a workload. In some embodiments, one resource predictor 132 may run multiple computations so as to predict the resource costs of a workload for each executor.

To predict resources a workload may use in a given service environment, the resource predictor 132 may weight the calculation to highlight a desired or notedly important variable such as cost and/or response time. Weighting the calculation according to preferences may enable a tailored service selection so as to, for example, steer the execution decision as preferred.

Costs incurred by a serverless service 170 and a microservice 190 may not be equally distributed among all timeslots; for the same task request, a serverless service 170 may be a more cost-effective service at a certain time whereas a microservice 190 may be a more cost-effective service at another time. Noise may be reduced, using sampling techniques as known in the art or as hereinafter developed, so as to enhance resource predictions.

An executor (e.g., a node of the selected service type) may be scaled and/or scheduled based on calculations and/or predictions made by the resource predictor 132. The resource predictor 132 may calculate, for example, necessary additional resources to fulfill the task request on the selected executor. The resource predictor 132 may use a formula known in the art or hereinafter developed to calculate predictions. For example, a formula the resource predictor 132 may use to calculate a prediction is:

$${RP}_{i} = \frac{{C}_{i}}{\sum C} * w + \frac{{R}_{i}}{\sum R} ( 1 - w ) \qquad Equation 1$$

where R is the average amount of response (which may also be referred to as the work done) to process a workload, Rᵢ is the amount of response to process a workload given a specific executor, Y R is the total amount of response to process a workload, Pᵢ is the prediction for a specific workload, Cᵢ is the cost for a workload given a specific executor, C is the average cost for the workload services, ΣC is the total cost for all available workload services, and w is the weight. The weight w may be any real number between 0 and 1 inclusive: w∈R|0≤w≤1.

The workload processor 124 may be in communication with a service selector 142. The service selector 142 may communicate with the schedulers of the available services in the system to determine which service may execute a task request and when the task request may be executed. The system 100 has a serverless service 170, a mixed service 180, and a microservice 190; the service selector 142 is thus in communication with a serverless scheduler 144 and a microservice scheduler 146. The schedulers communicate with a scale manager 148 which may be used to scale one or more services as necessary to service one or more task requests. A scale converter 152 may also be used to scale resources as appropriate.

The scale manager 148 and/or scale converter 152 may communicate with the available services via an interface 158. The interface 158 may connect the scale manager 148 and the scale converter 152 to system services such as, for example, a serverless service 170, a mixed service 180, and a microservice 190.

Each of the services may have nodes. The serverless service 170 has nodes 172-176, the mixed service 180 has nodes 182-186, and the microservices 190 has nodes 192-196. In some embodiments of the present disclosure, the nodes or resources of one service may be converted, reconfigured, reallocated, or repurposed to another service type; for example, if the system 100 determined, via an analysis from the resource analyzer 134 based on the usage data collected by the resource monitor 136, that the microservices 190 have more resources than necessary and that the serverless service 170 would be better served with some of those additional resources, the system 100 may convert node J 196 into a serverless resource such as by redirecting the resources from node J 196 to the serverless service 170 and, for example, either scaling node C 176 or deploying an additional serverless node to the serverless service 170.

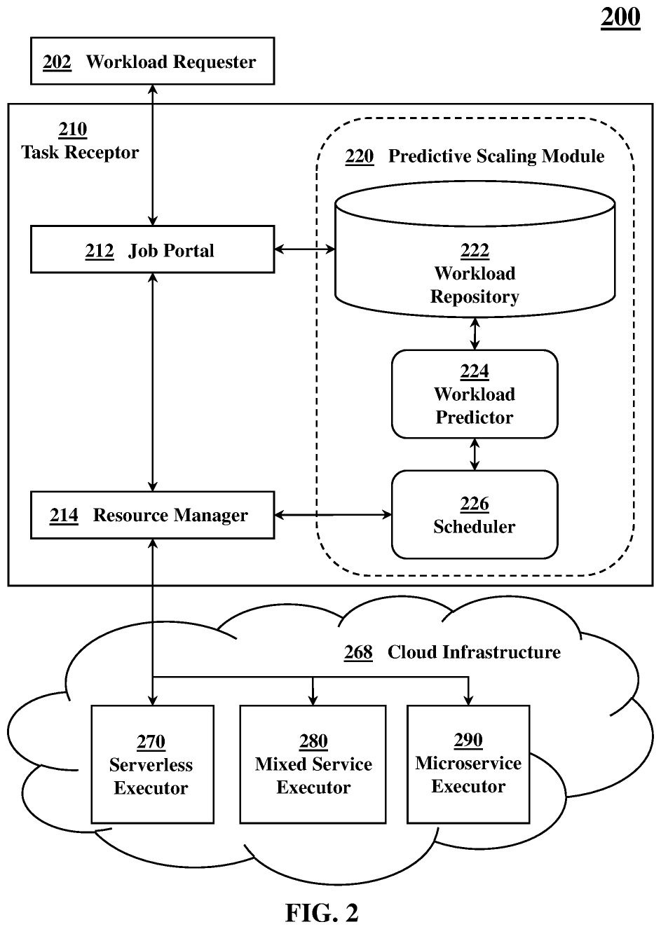

FIG. 2 depicts a resource management system 200 in accordance with some embodiments of the present disclosure. The resource management system 200 includes a workload requester 202, a task receptor 210, and a cloud infrastructure 268.

A workload requester 202 may submit a request for a task execution to a service system with a resource management system 200. The task request may be received by a job portal 212 of the task receptor 210. The job portal 212 may be in communication with a predictive scaling module 220 and a resource manager 214.

The predictive scaling module 220 may include a workload repository 222 which is in communication with a workload predictor 224 and a workload scheduler 226. The job portal 212 may send task data and/or metadata to the workload repository 222 of the predictive scaling module 220. The task data and/or metadata in the workload repository 222 may be used by the workload predictor 224 for, for example, training, testing, and/or sampling predictions; for example, the data and/or metadata may be used to build and/or refine a workload prediction model.

In some embodiments, the workload predictor 224 may use a workload prediction model to predict workloads and/or predict workload data. A workload prediction model may be a model that enables, enhances, or otherwise aids in the prediction of workloads; for example, the model may identify a recurring request for a weekly budget detail each Monday at noon and thus predict the same request for the following Monday at noon. In some embodiments, a workload prediction model may be an AI model. Mechanisms known in the art or hereinafter developed may be used by the workload predictor 224 such as, for example, support vector machine (SVM), fast Fourier transformation (FFT), and/or reverse stepwise linear regression (RSLR).

The workload predictor 224 may be in communication with a scheduler 226. The workload predictor 224 may send the scheduler 226 one or more prediction results such that the predictive scaling module 220 may anticipate and plan for one or more predicted workloads by preparing and accounting for the anticipated workloads (and, e.g., the resources required for the anticipated workloads) using the scheduler 226.

The predictive scaling module 220 may communicate with the resource manager 214 about predictions and/or predictive scaling decisions such that the resource manager 214 may act on the predictions and/or predictive scaling decisions. For example, the resource manager 214 may receive a schedule from the scheduler 226 and submit tasks to the assigned resources for execution in accordance with the schedule. For example, the resource manager 214 may receive a predictive scaling decision such that one or more of the services are to be scaled; the resource manager 214 may scale the services in accordance with that decision.

The resource manager 214 may receive a task from the job portal 212 and information (e.g., a schedule and a scaling decision) from the predictive scaling module 220; the resource manager 214 may assign the task to a service in accordance with that information. The resource manager 214 may assign a task to a service on a cloud infrastructure 268.

The cloud infrastructure 268 may include access to one or more services. The resource management system 200 depicted includes multiple service types: a serverless executor 270, a mixed service executor 280, and a microservice executor 290. The serverless executor 270 may be, for example, a serverless node in a serverless cluster. The mixed service executor 280 may be, for example, a mixed service cluster offering at least one node that may be used as a serverless node and/or least one node that may be used as a microservice node. The microservice executor 290 may be, for example, a microservice node in a microservice cluster.

In some embodiments, the task receptor 210 may use data from characterizing correlated workload patterns across services to calculate predictions. These characterizing correlated workload patterns may have resulted from the dependencies of one or more applications running on the services. The task receptor 210 may use samples from multiple time series; for example, one set of samples may be from mid-morning of a workday whereas another set of samples may be taken in the late evening of the same day. In some embodiments, the workload data samples may be treated as a multiple time series.

In some embodiments, the workload predictor 224 may use a co-clustering algorithm to identify service groups and time periods in which one or more workload patterns appear in each group. Various techniques may be used to explore temporal correlations in workload pattern changes; such techniques may include, for example, SVM, FFT, RSLR, and the like. The workload predictor 224 may predict one or more individual service workloads based on the groups and/or the group data.

In some embodiments, the resource management system 200 may be part of a larger system (e.g., service provision system 100 of FIG. 1), and the task receptor 210 may be in communication, directly or indirectly, with a scale manager (e.g., scale manager 148 of FIG. 1). The scale manager may, for example, receive data from the workload predictor 224 and communicate with the resource manager 214 to enable proper scaling of a desired service.

A scale manager, which may also be referred to as a scaling service, may be used in accordance with various deployment practices. For example, if the requested traffic is above a defined threshold, the scale manager may select the relevant host and its processor where a new container may be deployed in order to run the service; the host, processor, and/or container may be selected for its optimal (e.g., lowest) energy cost. The scale manager may configure the network between the ingress point of the executor system (e.g., the FaaS cluster or the microservice cluster) and the container within the system (e.g., the node in the cluster). The scale manager may schedule the scaling function using predictions and/or scale the service in real time.

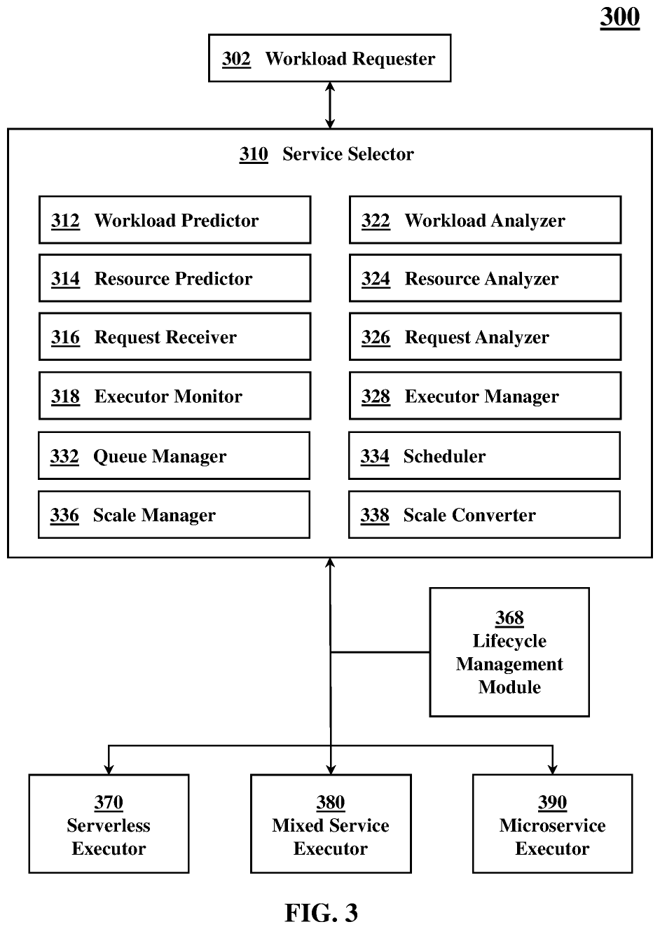

FIG. 3 illustrates an architecture of a service selection system 300 in accordance with some embodiments of the present disclosure. The service selection system 300 includes a workload requester 302 in communication with a service selector 310 which is in communication with multiple executors of differing types.

In the service selection system 300, a workload requester 302 may submit a workload request to the service selector 310. The service selector 310 may use one or more tools to determine which executor to submit the workload request to for optimal results (e.g., executing the task using minimal resources for completion within a defined period of time).

The service selector 310 may use various tools including, for example, a workload predictor 312, a workload analyzer 322, a resource predictor 314, a resource analyzer 324, a request receiver 316, a request analyzer 326, an executor monitor 318, an executor manager 328, a queue manager 332, a scheduler 334, a scale manager 336, a scale converter 338, and the like. The service selector 310 may use the tools to, for example, predict workloads, calculate available resources for the predicted workloads, and scale resources to meet expected demand.

The service selector 310 may receive multiple task requests from a workload requester 302 and use one or more tools to determine which service to assign tasks to for execution. The service selector 310 may determine that scheduling the execution of a task on a serverless executor 370 would be optimal for one task, that another task would optimally be queued for execution on a microservice executor 390, and that another task would best be served by immediate execution on the mixed service executor 380.

The service selector 310 may, for example, accept a task request from a workload requester 302 via a user application (e.g., user application 102 of FIG. 1). The service selector 310 may process the task request and determine it is to be executed immediately; alternatively, the service selector 310 may determine the task is to be queued and/or scheduled for asynchronous processing. The service selector 310 may process the request and determine the type of executor that the task request is to be assigned to based on analyses from, for example, the workload predictor 312 and the resource predictor 314.

In some embodiments, the service selection system 300 may include, or communicate with, a service lifecycle management module 368. The service lifecycle management module 368 may monitor and/or adjust the lifecycle of various service executors based on data and analytics about the services, executors, requests, predictions, and the like.

The service lifecycle management module 368 may collect metrics about the serverless executor 370, the mixed service executor 380, and/or the microservice executor 390. The service lifecycle management module 368 may adjust the lifecycle of one or more of the different types of services according to the collected metrics, usage data, usage patterns, usage trends, and the like. For example, for a FaaS executor with frequent provision and destruction, a cost model may evaluate the executor as “save” and convert it into a long run executor. For example, for a microservice executor 390 without frequent usage, the service lifecycle management module 368 may determine the system 300 may be optimized by converting the executor into a serverless executor 370 based on a cost model evaluating the executor as “save.” In some embodiments, services without a usage pattern (e.g., a service with limited or no usage history) may be provisioned with a long run time; such services may be pruned, cleaned, and otherwise optimized according to the usage model as usage data becomes available.

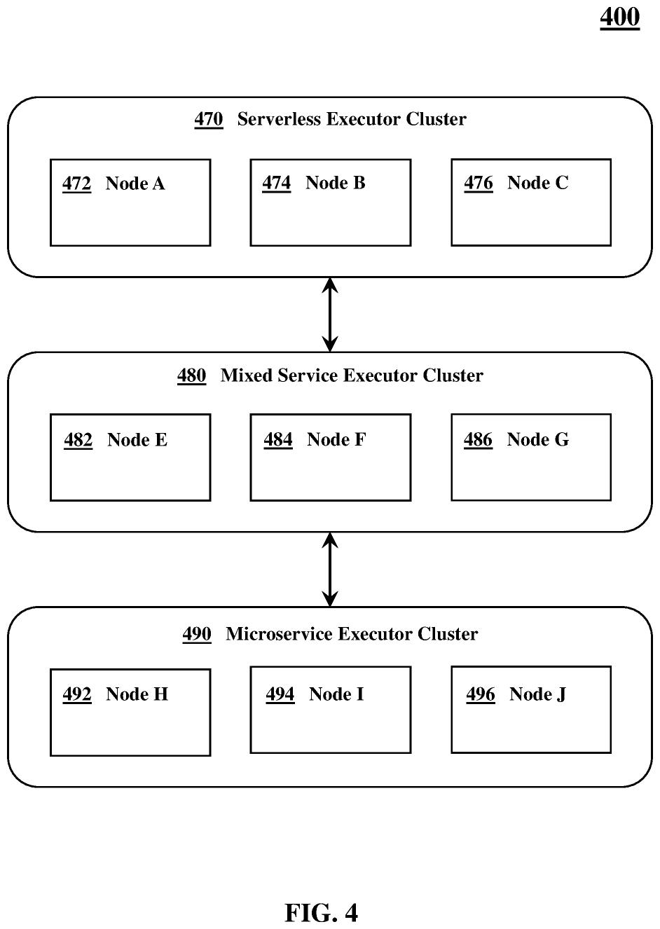

FIG. 4 depicts an executor configuration mechanism 400 in accordance with some embodiments of the present disclosure. The executor configuration mechanism 400 offers multiple service types: a serverless executor cluster 470, a mixed service executor cluster 480, and a microservice executor cluster 490. Each of the clusters have nodes: the serverless executor cluster 470 has nodes 472-476, the mixed service executor cluster 480 has nodes 482-486, and a microservice executor cluster 490 has nodes 492-496.

The clusters may communicate with each other; the mixed service executor cluster 480 is in direct communication with both the serverless executor cluster 470 and the microservice executor cluster 490, and the serverless executor cluster 470 is in indirect communication with the microservice executor cluster 490 via the mixed service executor cluster 480.

The clusters may communicate with each other such that the nodes may be exchanged between the clusters. For example, a system (e.g., service provision system 100 of FIG. 1) may determine that node B 474 in the serverless executor cluster 470 may better service the system and/or users thereof as part of the mixed service executor cluster 480 and may thus move the node from the serverless executor cluster 470 to the mixed service executor cluster 480. In some embodiments, a system (e.g., service provision system 100 of FIG. 1) may determine that node B 474 in the serverless executor cluster 470 may better service the system and/or users thereof as a microservice resource and in the microservice executor cluster 490; the system may thus move the node from the serverless executor cluster 470 to the mixed service executor cluster 480, convert the node 474 into a microservice-type node, and move the new microservice-type node into the microservice executor cluster 490. Similarly, a system may determine that a microservice node would better serve the system as a serverless node and may thus convert the node to a serverless node and/or migrate the microservice node to another cluster.

In some embodiments of the present disclosure, a workload may be assigned to a particular service type (e.g., type of executor) based on the workload type, workload data, workload metadata, analyses about such information, and the like.

For a predicted workload, the system may determine (e.g., via a workload predictor 126 and resource predictor 132 as shown in FIG. 1) that the workload may be completed in a configured time with the available resources and that, as a result, no new service instances would be initiated. Alternatively, for another predicted workload, the system may determine that the workload will not be able to be completed in a configured time given the available resources; as a result, the system may initiate a new instance (e.g., a new node) to service the workload. In some embodiments, a system may determine that a new instance will be initiated for a predicted workload and that the system will wait to initiate the new instance until another workload currently running may be completed such that the resources used for that workload may be released for use by the new instance.

In some embodiments, a user may configure thresholds for each of the services. For example, a user may configure a minimum, and a provided service may exceed the minimum value for a workload; the system may finish the workload in a configured time by pausing one or more other instances to release resources from those instances such that the resources may be rerouted to the workload so as to complete the workload in the configured time.

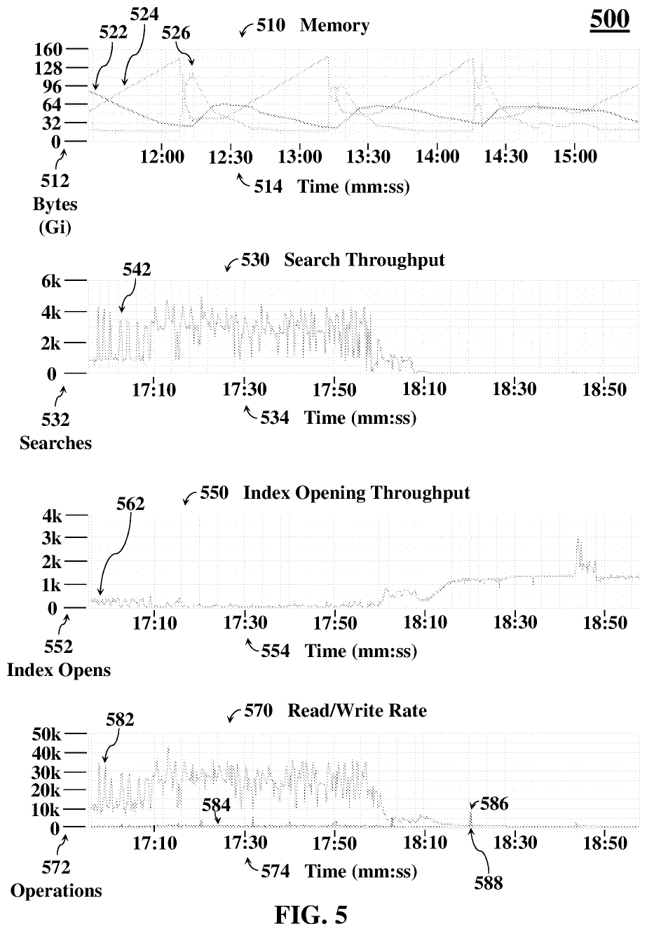

FIG. 5 illustrates a dataset 500 of resource monitoring graphs in accordance with some embodiments of the present disclosure. The dataset 500 includes a memory graph 510, a search throughput graph 530, an index opening throughput graph 550, and a read/write rate graph 570.

The memory graph 510 plots system memory 512 (as shown on the y-axis, measured in gibibytes) over time 514 (as shown on the x-axis, with units of minutes-and-seconds, mm:ss format). The memory graph 510 shows a memory cached plotline 522, a memory used plotline 524, and a free memory plotline 526 (e.g., memory that is available for use) over time 514.

The search throughput graph 530 plots system searches 532 (as shown on the y-axis) over time 534 (as shown on the x-axis, with units of minutes-and-seconds, mm:ss format). The search throughput graph 530 tracks a system searches plotline 542 over time 534.

The index opening throughput graph 550 shows the index opens 552 (shown on the y-axis) over time 554 (as shown on the x-axis, with units of minutes-and-seconds, mm:ss format). The index opening throughput graph 550 tracks an index opens plotline 562 over time 554.

The read/write rate graph 570 shows the operations 572 (shown on the y-axis) over time 574 (as shown on the x-axis, with units of minutes-and-seconds, mm:ss format). The read/write rate graph 570 tracks a database (DB) reads plotline 582, a DB writes plotline 584, a map_doc commands plotline 586, and a view emits plotline 588.

Data portrayed in the graphs in the dataset 500 may be used in predicting workloads, resources, scheduling, service lifecycles, and the like. For example, a system (e.g., the service provision system 100 of FIG. 1) may use the data in the dataset 500 to identify an optimal host service for a task request submitted by a user (e.g., via user application 102 of FIG. 1). The data shown in the dataset 500 may be collected via one or more service monitors (e.g., resource monitor 136 of FIG. 1 and/or executor monitor 318 of FIG. 3).

One or more mechanisms may be used for data collection to accumulate data similar to that in the dataset 500. The data collected may include, for example, resource usage data for the executors and/or clusters in the system (e.g., the nodes and their related serverless, microservice, or mixed service cluster). Data collection mechanisms may include, for example, server-based agent software, in-line network collectors, out-of-band network collectors, and the like.

Information may also be collected from the execution of tasks. Specifically, task execution for each type of service may generate useful data such as, for example, instantaneous resource usage, behavioral aspects, and the like; behavioral aspects may include, for example, resource usage history over time and/or microservice workflow. Collected metrics may include, for example, CPU, memory, disk and network bandwidth, message source and destination, payload size, response time, contextual data, and the like. Contextual data may include, for example, hypertext transfer protocol (HTTP) headers and/or response codes.

Data in the dataset 500 may be accumulated and/or analyzed to be used in predicting workloads, resources, scheduling, service lifecycles, and the like. For example, a system (e.g., the service provision system 100 of FIG. 1) may analyze (e.g., with a resource analyzer 134 of FIG. 1 and/or a workload analyzer 322 of FIG. 3) the data in the dataset 500 to identify an opportunity to optimize resources via a resource lifecycle adjustment (e.g., which may be made by the service lifecycle management module 368 of FIG. 3). The data shown in the dataset 500 may be calculated and/or analyzed via one or more analyzers (e.g., workload analyzer 322 of FIG. 3, resource analyzer 324 of FIG. 3, and/or request analyzer 326 of FIG. 3).

A resource analyzer (e.g., resource analyzer 324 of FIG. 3) may be used to analyze one or more usage data and/or usage patterns for one or more workloads. For example, resource consumption including energy consumption and/or cost may be tracked and/or analyzed. A resource selection cost model may be built for one or more configurations of a service provider. For example, a model may be built to for each configuration in a system such that a system with a serverless cluster, a microservices cluster, and a mixed use cluster (e.g., the executor configuration mechanism 400 of FIG. 4) may have three models for the system: a serverless cluster model, a microservices cluster model, and a mixed use cluster model. Each model in the system may benefit from collected data (e.g., the data shown in dataset 500 of FIG. 5). The models may be used to generate and/or enhance the robustness of a knowledge base so as to improve workload dispatch and/or task request optimization.

A resource predictor (e.g., resource predictor 132 of FIG. 1) may predict resources necessary to execute a particular task or a group of tasks based on data (e.g., as shown in dataset 500 of FIG. 5) collected (e.g., via resource monitor 136 of FIG. 1), generated (e.g., via resource analyzer 134 of FIG. 1), and the like. The resource predictor may predict the resources that are available in the system, that will be available in the system at a future time, whether the current resources are enough to service all current and predicted tasks, whether one or more of the services should be scaled to adequately service tasks, and the like. In some embodiments, more a unique resource predictor may be used for each instance, cluster, and/or workload type; in some embodiments, one resource predictor may run multiple computations so as to predict the resource costs of a workload for each executor.

A computer-implemented method in accordance with the present disclosure may include receiving a task request from a user and determining a preferred executor type for the task request. The method may include selecting an executor of the preferred executor type for the task request. The method may include performing the task request with the executor and returning a response to the task request to the user.

In some embodiments of the present disclosure, the method may include obtaining usage data and analyzing the usage data to identify a usage pattern. In some embodiments of the present disclosure, the method may further include building a resource selection model from the usage pattern and identifying the preferred executor type with the resource selection model. In some embodiments of the present disclosure, the resource selection model may be a cost model such that the cost is calculated by the model for each resource option; in such embodiments, the resource selection model may be referred to as a resource selection cost model or a resource selection cost-based model. In some embodiments of the present disclosure, the method may include adjusting a lifecycle of the executor based on the usage data.

In some embodiments of the present disclosure, the preferred executor type may be selected from a group consisting of serverless type, microservice type, and mixed service type.

In some embodiments of the present disclosure, the method may include converting an executor from a first executor type to a second executor type. For example, the operations may include converting a microservice node to a serverless node or vice versa.

In some embodiments of the present disclosure, the method may include scaling resources of the executor. In some embodiments, the function may include scaling in or scaling down the resources of another executor and reallocating the resources to the executor.

In some embodiments of the present disclosure, the method may include detecting the executor has inadequate resources to execute the task request. In some embodiments, the method may include balancing and/or scaling resources in the system to enable the system to execute the task. In some embodiments, the method may include queuing or scheduling the task.

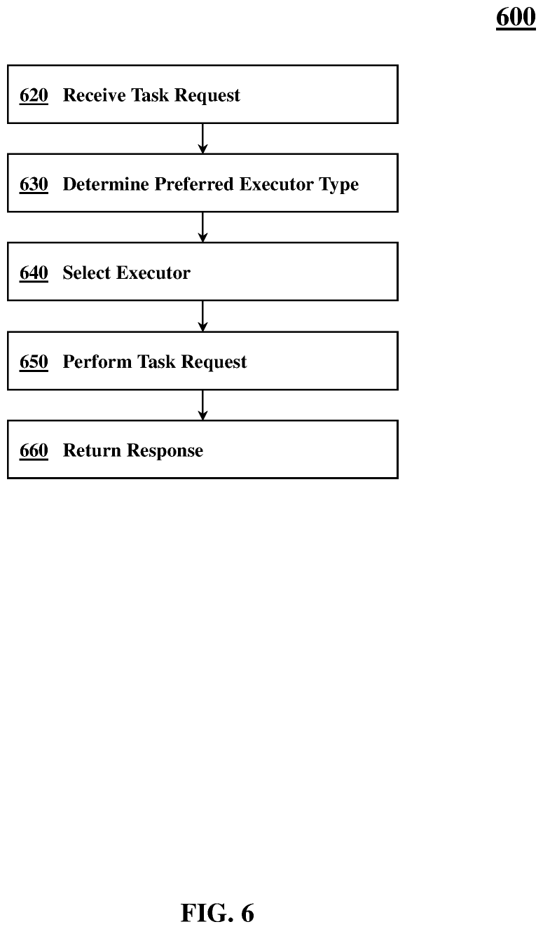

FIG. 6 depicts a computer implemented service selection method 600 in accordance with some embodiments of the present disclosure. The method 600 includes receiving 620 a task request and determining 630 a preferred executor type. The method 600 includes selecting 640 the executor to execute the task, performing 650 the task request, and returning 660 a response to the task request.

The method 600 includes receiving 620 a task request. A user may submit a task request (e.g., via a laptop, tablet, or smartphone with a user application 102 such as the one shown in FIG. 1) to the system (e.g., the service provision system 100 of FIG. 1). In some embodiments, a system receiving 620 a task request may use a service processor (e.g., the service processor 120 of FIG. 1) to receive (e.g., via the queue manager 122 of FIG. 1) and/or process (e.g., using the workload processor 124 of FIG. 1) the task request.

The method 600 includes determining 630 a preferred and/or optimal executor type. A system may use one or more predictors (e.g., the resource predictor 132 of FIG. 1 and/or the workload predictor 224 of FIG. 2) to determine a preferred and/or optimal executor type. A system may use one or more models (e.g., a predictive model, a resource selection model, a cost estimation model, and/or an AI model) to calculate the impact (e.g., resource consumption and/or system strain) of executing a task with one or more potential executors. Determining 630 a preferred and/or optimal executor type may include comparing data and/or analytics regarding the impact of the execution of the requested task and identifying which executor type best fits the priorities of the system (e.g., which executor type offers the fastest results or the most cost-efficient execution). In some embodiments, determining 630 a preferred and/or optimal executor type may consider one or more scheduled tasks and the needs and/or priorities of the scheduled tasks.

The method 600 includes selecting 640 the executor to execute the task. Selecting 640 an executor may include, for example, identifying one or more executor options (e.g., nodes capable of performing the task). In some embodiments, selecting 640 an executor may include either deciding to immediately perform the requested task or to schedule the requested task for performance at a later time via an identified executor option.

The method 600 includes performing 650 the task requested. Performing 650 the task requested may include submitting the task to the selected executor (e.g., node G 486 of FIG. 4) and executing the task with the selected executor.

The method 600 includes returning 660 a response to the task request. Returning 660 the response to the task request may include, for example, the executor either directly or indirectly delivering a response to the original query. The response may be, for example, a calculation, a search result, a computation, an answer to a question, a confirmation of a success, or the like. The response may be returned to a user (e.g., via a user application 102 as shown in FIG. 1) and/or a requester of the task (e.g., to the workload requester 302 as shown in FIG. 3).

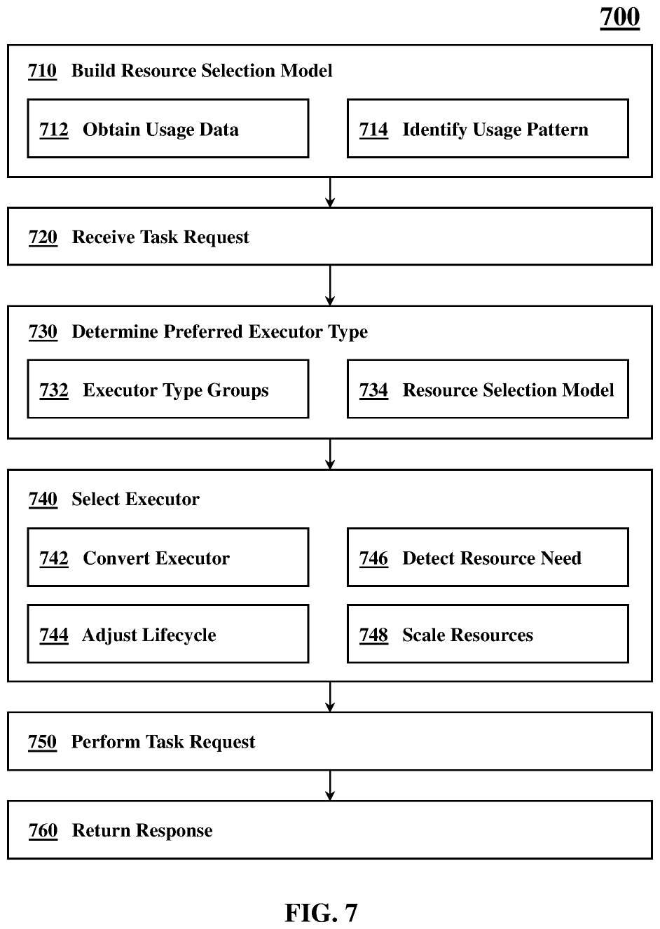

FIG. 7 illustrates a computer implemented service selection method 700 in accordance with some embodiments of the present disclosure. The method 700 includes building 710 a resource selection model and receiving 720 a task request. The method 700 includes determining 730 a preferred executor type and selecting 740 an executor. The method 700 includes performing 750 the task requested and returning 760 a response to the task requested.

Building 710 a resource selection model may include obtaining 712 usage data. Usage data may include, for example, the amount of power used by a particular resource type to execute a certain task, the frequency of a certain type of task request, the schedulability of a task type, and the like. Usage data may be obtained by monitoring and/or analyzing workloads (e.g., via a job portal 212 as shown in FIG. 2) and/or resources (e.g., via a resource monitor 136 as shown in FIG. 1 and/or an executor monitor 318 as shown in FIG. 3). Usage data may be stored locally (e.g., in a workload repository 222 as shown in FIG. 2) and/or externally. In some embodiments, usage data may be analyzed (e.g., with a workload analyzer 322, resource analyzer 324, and/or a request analyzer 326 as shown in FIG. 3) to obtain additional data (e.g., analyses and/or metadata).

Building 710 a resource selection model may include identifying 714 a usage pattern. In some embodiments, a resource selection model may be built with raw data (e.g., data collected via a service processor 120 as shown in FIG. 1 and/or an executor monitor 318 as shown in FIG. 3) such that the resource selection model may use structured and/or unstructured machine learning (ML), such as deep learning (DL) and/or an artificial neural network (ANN), and/or other AI techniques for identifying 714 one or more usage patterns in the usage data. In some embodiments, an analyzer (e.g., a workload analyzer 322, resource analyzer 324, and/or a request analyzer 326 as shown in FIG. 3) may identify one or more usage patterns. In some embodiments, a resource selection model may be built using a combination of raw data and analyses inputs.

The method 700 includes receiving 720 a task request. A user may submit a task request (e.g., via a laptop, tablet, or smartphone with a user application 102 such as the one shown in FIG. 1) to the system (e.g., the service provision system 100 of FIG. 1). In some embodiments, a system receiving 720 a task request may use a service processor (e.g., the service processor 120 of FIG. 1) to receive (e.g., via the queue manager 122 of FIG. 1) and/or process (e.g., using the workload processor 124 of FIG. 1) the task request.

The method 700 includes determining 730 a preferred and/or optimal executor type. A system may use one or more predictors (e.g., the resource predictor 132 of FIG. 1 and/or the workload predictor 224 of FIG. 2) to determine a preferred and/or optimal executor type. A system may use one or more models (e.g., a predictive model, a resource selection model, a cost estimation model, and/or an AI model) to calculate the impact (e.g., resource consumption and/or system strain) of executing a task with one or more potential executors. Determining 730 a preferred and/or optimal executor type may include comparing data and/or analytics regarding the impact of the execution of the requested task and identifying which executor type best fits the priorities of the system (e.g., which executor type offers the fastest results or the most cost-efficient execution). In some embodiments, determining 730 a preferred and/or optimal executor type may consider one or more scheduled tasks and the needs and/or priorities of the scheduled tasks.

Determining 730 a preferred executor type may include considering executor type groups 732 (e.g., serverless versus microservice) and/or a resource selection model 734. In some embodiments, a resource selection model 734 may consider executor type groups 732; for example, data about the available executor type groups 732 may be included in the data used to train the resource selection model 734. In some embodiments, determining 730 a preferred executor type may include considering the resource selection model 734 and assessing whether a recommended executor type is among the available executor type groups 732. In some embodiments, determining a preferred executor type may include detecting which executor type groups 732 are available in the system (e.g., which executor types the system has access to, such as service provision system 100 as shown in FIG. 1 having access to serverless service 170, mixed service 180, and microservice 190 options) and submitting that data to the resource selection model 734 such that the resource selection model 734 may recommend an executor type based on the executor types currently available to the system.

The method 700 includes selecting 740 an executor to execute the task received in the task request. Selecting 740 an executor to execute a task may include, for example, converting 742 an executor from one type to another type, adjusting 744 the lifecycle of one or more executors, detecting 746 a resource need, and/or scaling 748 resources.

Selecting 740 an executor to execute a task may include converting 742 an executor from one type to another type. Converting 742 an executor may include, for example, exchanging one or more nodes and/or node resources between clusters of different executor types. For example, in some embodiments, converting 742 an executor from one executor type to a different executor type may include moving a node from a microservice cluster (e.g., microservice executor cluster 490 as shown in FIG. 4) to a mixed service cluster (e.g., mixed service executor cluster 480 as shown in FIG. 4), reconfiguring the node into a serverless node, and further migrating the node to a serverless cluster (e.g., serverless executor cluster 470 as shown in FIG. 4). In some embodiments, converting 742 an executor may include, for example, reducing the resources available to a node in one cluster (e.g., node A 472 as shown in FIG. 4) and reallocating those resources instead to a node in another cluster (e.g., node H 492 of FIG. 4). In some embodiments, both node migration and resource reallocation may be used to convert an executor.

Selecting 740 an executor to execute a task may include adjusting 744 the lifecycle of one or more executors. A lifecycle manager (e.g., the service lifecycle management module 368 as shown in FIG. 3) may be used to manage and/or adjust executor lifecycles; a lifecycle manager may monitor and/or adjust the lifecycle of various service executors based on data and analytics about the services, executors, requests, predictions, and the like. A lifecycle manager may collect metrics about one or more executors available to the system and may adjust the lifecycle of one or more of the different types of services according to the collected metrics, usage data, usage patterns, usage trends, and the like.

Selecting 740 an executor to execute a task may include detecting 746 a resource need. Detecting 746 a resource need may include, for example, one or more monitors (e.g., the resource monitor 136 as shown in FIG. 1) collecting data, the system analyzing the data (e.g., via a resource analyzer 134 as shown in FIG. 1), and/or one or more predictors (e.g., the resource predictor 132 and/or and the workload predictor 126 of FIG. 1) predicting a resource shortfall such that either additional resources will need to be deployed or the task will need to be queued or scheduled for another time because the system will not have the resources available to perform the task. In some embodiments, detecting 746 a resource need may be a trigger for resource allocation in the system (e.g., converting 742 executors, adjusting 744 lifecycles, and/or scaling 748 resources).

Selecting 740 an executor to execute a task may include scaling 748 resources. In some embodiments, scaling 748 resources may be the result of detecting 746 a resource need such that the system scales up or scales out to provide the necessary resources for the received task request. In some embodiments, scaling 748 resources may be the result of recognizing an excess of available resources to a particular part of the system such that the system scales in or scales down the resources to make those resources available elsewhere in the system and/or to reduce energy consumption. In some embodiments, scaling 748 resources may include scaling some resources in and/or down and reallocating those resources to scale other resources out and/or up.

Selecting 740 an executor may include, for example, identifying one or more executor options (e.g., nodes capable of performing the task). In some embodiments, selecting 740 an executor may include either deciding to immediately perform the requested task or to schedule the requested task for performance at a later time. In some embodiments, an executor may be selected, and its resources may be scaled to meet the resource demands of the task request. In some embodiments, selecting 740 an executor may include detecting 746 a resource need, adjusting 744 the lifecycle of one or more executors to reclaim unused resources, and scaling 748 the resources available to the selected executor.

The method 700 includes performing 750 the task requested. Performing 750 the task requested may include submitting the task to the selected executor and executing the task by the selected executor. In some embodiments, performing 750 the requested task may include immediate execution thereof; in some embodiments, performing 750 the requested task may include queuing and/or scheduling the task for a later execution.

The method 700 includes returning 760 a response to the task request. Returning 760 the response to the task request may include, for example, the executor either directly or indirectly delivering a response to the original query. The response may be, for example, a calculation, a search result, a computation, an answer to a question, a confirmation of a success, or the like. The response may be returned to a user (e.g., via a user application 102 as shown in FIG. 1) and/or a requester of the task (e.g., to the workload requester 302 as shown in FIG. 3).

A computer program product in accordance with the present disclosure may include a computer readable storage medium having program instructions embodied therewith. The program instructions may be executable by a processor to cause the processor to perform a function. The function may include receiving a task request from a user and determining a preferred executor type for the task request. The function may include selecting an executor of the preferred executor type for the task request. The function may include performing the task request with the executor and returning a response to the task request to the user.

In some embodiments of the present disclosure, the function may include obtaining usage data and analyzing the usage data to identify a usage pattern. In some embodiments of the present disclosure, the function may further include building a resource selection model from the usage pattern and identifying the preferred executor type with the resource selection model. In some embodiments of the present disclosure, the resource selection model may be a cost model such that the cost is calculated by the model for each resource option; in such embodiments, the resource selection model may be referred to as a resource selection cost model or a resource selection cost-based model. In some embodiments of the present disclosure, the function may include adjusting a lifecycle of the executor based on the usage data.

In some embodiments of the present disclosure, the preferred executor type may be selected from a group consisting of serverless type, microservice type, and mixed service type.

In some embodiments of the present disclosure, the function may include converting an executor from a first executor type to a second executor type. For example, the operations may include converting a microservice node to a serverless node or vice versa.

In some embodiments of the present disclosure, the function may include scaling resources of the executor. In some embodiments, the function may include scaling in or scaling down the resources of another executor and reallocating the resources to the executor.

In some embodiments of the present disclosure, the function may include detecting the executor has inadequate resources to execute the task request. In some embodiments, the operations may include balancing and/or scaling resources in the system to enable the system to execute the task. In some embodiments, the operations may include queuing the task or scheduling the task for a later time.

It is noted that various aspects of the present disclosure may be described by narrative text, flowcharts, block diagrams of computer systems, and/or block diagrams of the machine logic included in computer program product (CPP) embodiments. With respect to any flowcharts (depending upon the technology involved), the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices.

The storage media may collectively include machine readable code corresponding to instructions and/or data for performing computer operations. A “storage device” may refer to any tangible hardware or device that can retain and store instructions for use by a computer processor. Without limitation, the computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc), or any suitable combination thereof. A computer-readable storage medium should not be construed as storage in the form of transitory signals per se such as radio waves, other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation, or garbage collection, but this does not render the storage device transitory because the data is not transitory while it is stored.

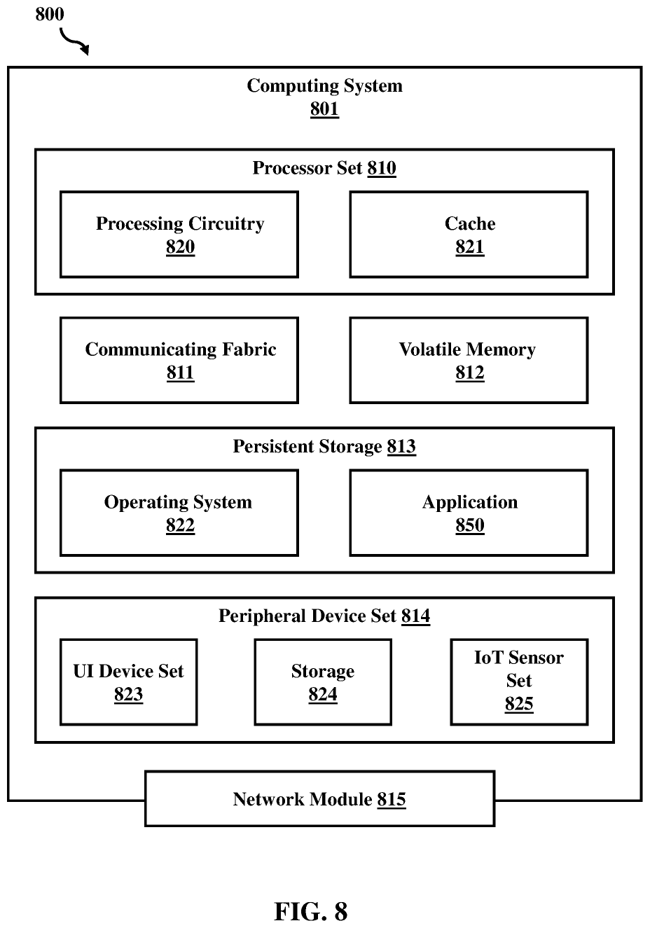

Referring now to FIG. 8, illustrated is a block diagram describing an embodiment of a computing system 801 within in a computing environment 800. The computing environment 800 may be a simplified example of a computing device (e.g., a physical bare metal system and/or a virtual system) capable of performing the computing operations described herein. Computing system 801 may be representative of the one or more computing systems or devices implemented in accordance with the embodiments of the present disclosure and further described below in detail. It should be appreciated that FIG. 8 provides only an illustration of one implementation of a computing system 801 and does not imply any limitations regarding the environments in which different embodiments may be implemented. In general, the components illustrated in FIG. 8 may be representative of an electronic device, either physical or virtualized, capable of executing machine-readable program instructions.

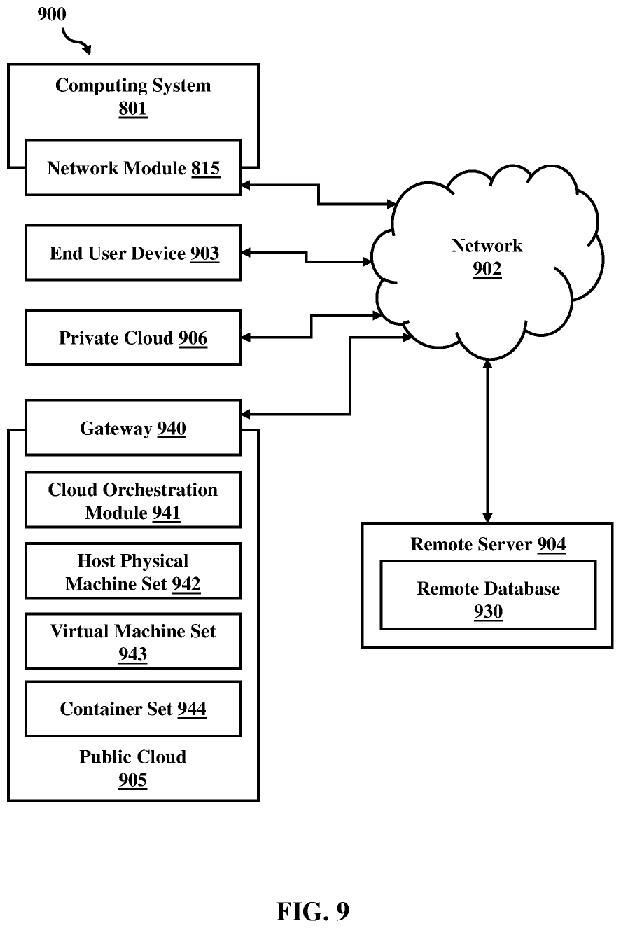

Embodiments of computing system 801 may take the form of a desktop computer, laptop computer, tablet computer, smart phone, smart watch or other wearable computer, mainframe computer, server, quantum computer, a non-conventional computer system such as an autonomous vehicle or home appliance, or any other form of computer or mobile device now known or to be developed in the future that is capable of running an application 850, accessing a network (e.g., network 902 of FIG. 9), or querying a database (e.g., remote database 930 of FIG. 9). Performance of a computer-implemented method executed by a computing system 801 may be distributed among multiple computers and/or between multiple locations. Computing system 801 may be located as part of a cloud network, even though it is not shown within a cloud in FIG. 8 or FIG. 9. Moreover, computing system 801 is not required to be in a cloud network except to any extent as may be affirmatively indicated.

The processor set 810 includes one or more computer processors of any type now known or to be developed in the future. Processing circuitry 820 may be distributed over multiple packages such as, for example, multiple coordinated integrated circuit chips. Processing circuitry 820 may implement multiple processor threads and/or multiple processor cores. The cache 821 may refer to memory that is located on the processor chip package(s) and/or may be used for data and/or code that can be made available for rapid access by the threads or cores running on the processor set 810. Cache 821 memories can be organized into multiple levels depending upon relative proximity to the processing circuitry 820. Alternatively, some or all of the cache 821 may be located “off chip.” In some computing environments, the processor set 810 may be designed for working with qubits and performing quantum computing.

Computer readable program instructions can be loaded onto the computing system 801 to cause a series of operational steps to be performed by the processor set 810 of the computing system 801 and thereby implement a computer-implemented method. Execution of the instructions can instantiate the methods specified in flowcharts and/or narrative descriptions of computer-implemented methods included in this specification (collectively referred to as “the inventive methods”). The computer readable program instructions can be stored in various types of computer readable storage media, such as cache 821 and the other storage media discussed herein. The program instructions, and associated data, can be accessed by the processor set 810 to control and direct performance of the inventive methods. In the computing environments of FIG. 8 and FIG. 9, at least some of the instructions for performing the inventive methods may be stored in persistent storage 813, volatile memory 812, and/or cache 821 as application(s) 850 comprising one or more running processes, services, programs, and installed components thereof. For example, program instructions, processes, services and installed components thereof may include the components and/or sub-components of the service provision system 100 as shown in FIG. 1 and/or the resource management system 200 as shown in FIG. 2.

The communication fabric 811 may refer to signal conduction paths that may allow the various components of the computing system 801 to communicate with each other. For example, communications fabric 811 may provide for electronic communication among the processor set 810, volatile memory 812, persistent storage 813, peripheral device set 814, and/or network module 815. The communication fabric 811 may be made of switches and/or electrically conductive paths, such as the switches and electrically conductive paths that make up busses, bridges, physical input/output ports, and the like. Other types of signal communication paths may be used such as fiber optic communication paths and/or wireless communication paths.

The volatile memory 812 may refer to any type of volatile memory now known or to be developed in the future. The volatile memory 812 may be characterized by random access; random access is not required unless affirmatively indicated. Examples include dynamic-type random access memory (RAM) or static-type RAM. In the computing system 801, the volatile memory 812 is located in a single package and can be internal to computing system 801; in some embodiments, either alternatively or additionally, the volatile memory 812 may be distributed over multiple packages and/or located externally with respect to the computing system 801. The application 850, along with any program(s), processes, services, and installed components thereof, described herein, may be stored in volatile memory 812 and/or persistent storage 813 for execution and/or access by one or more of the respective processor sets 810 of the computing system 801.

Persistent storage 813 may be any form of non-volatile storage for computers that may be currently known or developed in the future. The non-volatility of this storage means that the stored data may be maintained regardless of whether power is being supplied to the computing system 801 and/or directly to persistent storage 813. Persistent storage 813 may be a read-only memory (ROM); at least a portion of the persistent storage 813 may allow writing of data, deletion of data, and/or re-writing of data. Some forms of persistent storage 813 may include magnetic disks, solid-state storage devices, hard drives, flash-based memory, erasable read-only memories (EPROM), and semi-conductor storage devices. An operating system 822 may take several forms, such as various known proprietary operating systems or open-source portable operating system interface-type operating systems that employ a kernel.

The peripheral device set 814 may include one or more peripheral devices connected to computing system 801, for example, via an input/output (I/O) interface. Data communication connections between the peripheral devices and the other components of computing system 801 may be implemented using various methods. For example, data communication connections may be made using short-range wireless technology (e.g., a Bluetooth® connection), Near-Field Communication (NFC), wired connections or cables (e.g., universal serial bus (USB) cables), insertion-type connections (e.g., a secure digital (SD) card), connections made though local area communication networks, and/or wide area networks (e.g., the internet).

In various embodiments, the UI device set 823 may include components such as a display screen, speaker, microphone, wearable devices (e.g., goggles, headsets, and smart watches), keyboard, mouse, printer, touchpad, game controllers, and/or haptic feedback devices.

The storage 824 may include external storage (e.g., an external hard drive) or insertable storage (e.g., an SD card). The storage 824 may be persistent and/or volatile. In some embodiments, the storage 824 may take the form of a quantum computing storage device for storing data in the form of qubits.

In some embodiments, networks of computing systems 801 may utilize clustered computing and components acting as a single pool of seamless resources when accessed through a network by one or more computing systems 801. For example, networks of computing systems 801 may utilize a storage area network (SAN) that is shared by multiple, geographically distributed computer systems 801 or network-attached storage (NAS) applications.

An IoT sensor set 825 may be made up of sensors that can be used in Internet-of-Things applications. A sensor may be a temperature sensor, motion sensor, infrared sensor, or any other type of known sensor type. One or more sensors may be communicably connected and/or used as the IoT sensor set 825 in whole or in part.

The network module 815 may include a collection of computer software, hardware, and/or firmware that allows the computing system 801 to communicate with other computer systems through a network 802 such as a LAN or WAN. The network module 815 may include hardware (e.g., modems or wireless signal transceivers), software (e.g., for packetizing and/or de-packetizing data for communication network transmission), and/or web browser software (e.g., for communicating data over the network).

In some embodiments, network control functions and network forwarding functions of the network module 815 may be performed on the same physical hardware device. In some embodiments, the control functions and the forwarding functions of network module 815 may be performed on physically separate devices such that the control functions manage several different network hardware devices; for example, embodiments that utilize software-defined networking (SDN) may perform control functions and forwarding functions of the network module 815 on physically separate devices. Computer readable program instructions for performing the inventive methods may be downloaded to the computing system 801 from an external computer or external storage device through a network adapter card and/or network interface included in the network module 815.

Continuing, FIG. 9 depicts a computing environment 900 operating as part of a network. The computing environment 900 of FIG. 9 may be an extension of the computing environment 800 of FIG. 8. In addition to computing system 801, computing environment 900 may include a network 902 (e.g., a WAN or other type of computer network) connecting the computing system 801 to an end user device (EUD) 903, remote server 904, public cloud 905, and/or private cloud 906.

In this embodiment, computing system 801 includes processor set 810 (including the processing circuitry 820 and the cache 821), the communication fabric 811, the volatile memory 812, the persistent storage 813 (including the operating system 822 and the program(s) 850, as identified above), the peripheral device set 814 (including the user interface (UI), the device set 823, the storage 824, and the Internet of Things (IoT) sensor set 825), and the network module 815 of FIG. 8.

In this embodiment, the remote server 904 includes the remote database 930. In this embodiment, the public cloud 905 includes gateway 940, cloud orchestration module 941, host physical machine set 942, virtual machine set 943, and/or container set 944.

The network 902 may be comprised of wired and/or wireless connections. For example, connections may be comprised of computer hardware such as copper transmission cables, optical transmission fibers, wireless transmission, routers, firewalls, switches, gateway computers, and/or edge servers. The network 902 may be described as a WAN (e.g., the internet) capable of communicating computer data over non-local distances by any technology for communicating computer data; the network 902 may make use of technology now known or to be developed in the future. In some embodiments, the WAN may be replaced and/or supplemented by LANs designed to communicate data between devices located in a local area (e.g., a wireless network). Other types of networks that can be used to interconnect the one or more computer systems 801, EUDs 903, remote servers 904, private cloud 906, and/or public cloud 905 may include a Wireless Local Area Network (WLAN), home area network (HAN), backbone network (BBN), peer to peer network (P2P), campus network, enterprise network, the Internet, single- or multi-tenant cloud computing networks, the Public Switched Telephone Network (PSTN), and any other network or network topology known by a person skilled in the art to interconnect computing systems 801.

The EUD 903 may include any computer device that can be used and/or controlled by an end user; for example, a customer of an enterprise that operates computing system 801. The EUD 903 may take any of the forms discussed above in connection with computing system 801. The EUD 903 may receive helpful and/or useful data from the operations of the computing system 801. For example, in a hypothetical case where the computing system 801 provides a recommendation to an end user, the recommendation may be communicated from the network module 815 of the computing system 801 through a WAN network 902 to the EUD 903; in this example, the EUD 903 may display (or otherwise present) the recommendation to an end user. In some embodiments, the EUD 903 may be a client device, (e.g., a thin client), thick client, mobile computing device (e.g., a smart phone), mainframe computer, desktop computer, and/or the like.

A remote server 904 may be any computing system that serves at least some data and/or functionality to the computing system 801. The remote server 904 may be controlled and used by the same entity that operates computing system 801. The remote server 904 represents the one or more machines that collect and store helpful and/or useful data for use by other computers (e.g., computing system 801). For example, in a hypothetical case where the computing system 801 is designed and programmed to provide a recommendation based on historical data, the historical data may be provided to the computing system 801 via a remote database 930 of a remote server 904.

Public cloud 905 may be any computing systems available for use by multiple entities that provide on-demand availability of computer system resources and/or other computer capabilities including data storage (e.g., cloud storage) and computing power without direct active management by the user. The direct and active management of the computing resources of the public cloud 905 may be performed by the computer hardware and/or software of a cloud orchestration module 941. The public cloud 905 may communicate through the network 902 via a gateway 940; the gateway 940 may be a collection of computer software, hardware, and/or firmware that allows the public cloud 905 to communicate through the network 902.

The computing resources provided by the public cloud 905 may be implemented by a virtual computing environment (VCE) or multiple VCEs that may run on one or more computers making up a host physical machine set 942 and/or the universe of physical computers in and/or available to public cloud 805. A VCE may take the form of a virtual machine (VM) from the virtual machine set 943 and/or containers from the container set 944.

VCEs may be stored as images. One or more VCEs may be stored as one or more images and/or may be transferred among and/or between one or more various physical machine hosts either as images and/or after instantiation of the VCE. A new active instance of the VCE may be instantiated from the image. Two types of VCEs may include VMs and containers. A container is a VCE that uses operating system-level virtualization in which the kernel may allow the existence of multiple isolated user-space instances called containers. These isolated user-space instances may behave as physical computers from the point of view of the programs 850 running in them. An application 850 running on an operating system 822 may utilize all resources of that computer such as connected devices, files, folders, network shares, CPU power, and quantifiable hardware capabilities. The applications 850 running inside a container of the container set 844 may only use the contents of the container and devices assigned to the container; this feature may be referred to as containerization. The cloud orchestration module 941 may manage the transfer and storage of images, deploy new instantiations of one or more VCEs, and manage active instantiations of VCE deployments.

Private cloud 906 may be similar to public cloud 905 except that the computing resources may only be available for use by a single enterprise. While the private cloud 906 is depicted as being in communication with the network 902 (e.g., the Internet), in other embodiments, a private cloud 806 may be disconnected from the internet entirely and only accessible through a local/private network.

In some embodiments, a hybrid cloud may be used; a hybrid cloud may refer to a composition of multiple clouds of different types (e.g., private, community, and/or public cloud types). In a hybrid cloud system, the plurality of clouds may be implemented or operated by different vendors. Each of the multiple clouds remains a separate and discrete entity; the larger hybrid cloud architecture is bound together by standardized or proprietary technology that enables orchestration, management, and/or data/application portability between the multiple constituent clouds. In this embodiment, the public cloud 905 and the private cloud 906 may be both part of a larger hybrid cloud environment.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system, said system comprising:
a memory; and
a processor in communication with said memory, said processor being configured to perform operations, said operations comprising:
receiving a task request from a user;
determining a preferred executor type for said task request;
selecting an executor of said preferred executor type for said task request;
performing said task request with said executor; and
returning a response to said task request to said user.

2. The system of claim 1, further comprising:
obtaining usage data; and
analyzing said usage data to identify a usage pattern.

3. The system of claim 2, further comprising:
building a resource selection model from said usage pattern; and
identifying said preferred executor type with said resource selection model.

4. The system of claim 2, further comprising:
adjusting a lifecycle of said executor based on said usage data.

5. The system of claim 1, wherein:
said preferred executor type is selected from a group consisting of serverless type, microservice type, and mixed service type.

6. The system of claim 1, further comprising:
converting an executor from a first executor type to a second executor type.

7. The system of claim 1, further comprising:
scaling resources of said executor.

8. A computer-implemented method, said method comprising:
receiving a task request from a user;
determining a preferred executor type for said task request;
selecting an executor of said preferred executor type for said task request;
performing said task request with said executor; and
returning a response to said task request to said user.

9. The computer-implemented method of claim 8, further comprising:
obtaining usage data; and
analyzing said usage data to identify a usage pattern.

10. The computer-implemented method of claim 9, further comprising:
building a resource selection model from said usage pattern; and
identifying said preferred executor type with said resource selection model.

11. The computer-implemented method of claim 9, further comprising:
adjusting a lifecycle of said executor based on said usage data.

12. The computer-implemented method of claim 8, wherein:
said preferred executor type is selected from a group consisting of serverless type, microservice type, and mixed service type.

13. The computer-implemented method of claim 8, further comprising:
converting an executor from a first executor type to a second executor type.

14. The computer-implemented method of claim 8, further comprising:
scaling resources of said executor.

15. The computer-implemented method of claim 8, further comprising:
detecting said executor has inadequate resources to execute said task request.

16. A computer program product, said computer program product comprising a computer readable storage medium having program instructions embodied therewith, said program instructions executable by a processor to cause said processor to perform a function, said function comprising:
receiving a task request from a user;
determining a preferred executor type for said task request;
selecting an executor of said preferred executor type for said task request;
performing said task request with said executor; and
returning a response to said task request to said user.

17. The computer program product of claim 16, further comprising:
obtaining usage data;
analyzing said usage data to identify a usage pattern;
building a resource selection model from said usage pattern; and
identifying said preferred executor type with said resource selection model.

18. The computer program product of claim 16, wherein:
said preferred executor type is selected from a group consisting of serverless type, microservice type, and mixed service type.

19. The computer program product of claim 16, further comprising:
converting an executor from a first executor type to a second executor type.

20. The computer program product of claim 16, further comprising:
scaling resources of said executor.
